(19) United States
(12) Patent Application Publication
(10) Pub. No.: US 2021/0061392 A1
(43) Pub. Date: Mar. 4, 2021

(54) Bicycle Rearview Mirror

(71) Applicant: Dong-Lie Lee, Taichung City (TW)

(72) Inventor: Dong-Lie Lee, Taichung City (TW)

(21) Appl. No.: 16/553,049

(22) Filed: Aug. 27, 2019

(51) Int. Cl. B62J 29/00

(52) U.S. Cl. CPC B62J 29/00

(57) ABSTRACT

A rearview mirror includes a mirror frame and a mirror mount. The end of the mirror frame, which is connected to the mirror mount, is formed with a through hole. The mirror mount has an upper mount and a lower mount. The upper mount is pivotedly connected to the mirror frame and has a shrunk section. The lower mount has a receiving hole for being inserted by the shrunk section.

### TECHNICAL FIELD

The invention relates to bicycles, particularly to rearview mirrors for bicycles.

### RELATED ART

A driver or rider of a vehicle such as a car, a motorcycle or a bicycle must pay attention to rear traffic by rearview mirrors. Rearview mirrors are very important for bicycle riders, especially in urban commuting. Conventional rearview mirrors for bicycles have various drawbacks such as high wind resistance, heavy weight and limited adjustment range. Thus they are inconvenient for riders.

### SUMMARY OF THE INVENTION

An object of the invention is to provide a bicycle rearview mirror, which has low wind resistance, light weight and wide adjustment range.

To accomplish the above object, the bicycle rearview mirror of the invention includes a mirror frame and a mirror mount. The end of the mirror frame, which is connected to the mirror mount, is formed with a through hole. The mirror mount has an upper mount and a lower mount. The upper mount is pivotedly connected to the mirror frame and has a shrunk section. The lower mount has a receiving hole for being inserted by the shrunk section.

### BRIEF DESCRIPTION OF THE DRAWINGS

FIG. 1 is a perspective view of the invention;

FIG. 2 is an exploded view of the invention;

FIG. 3 is a partial cross-section view; and

FIG. 4 is a schematic view of the invention in a rotational status.

### DETAILED DESCRIPTION OF THE INVENTION

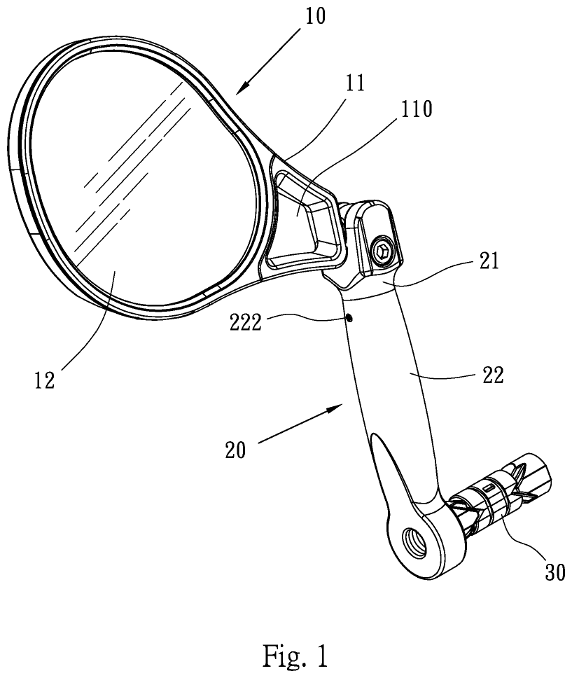

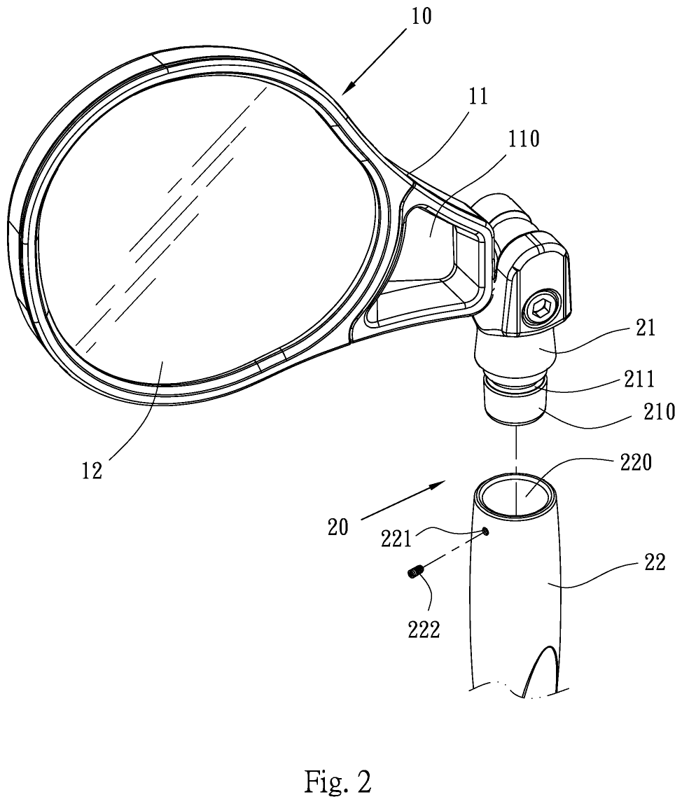

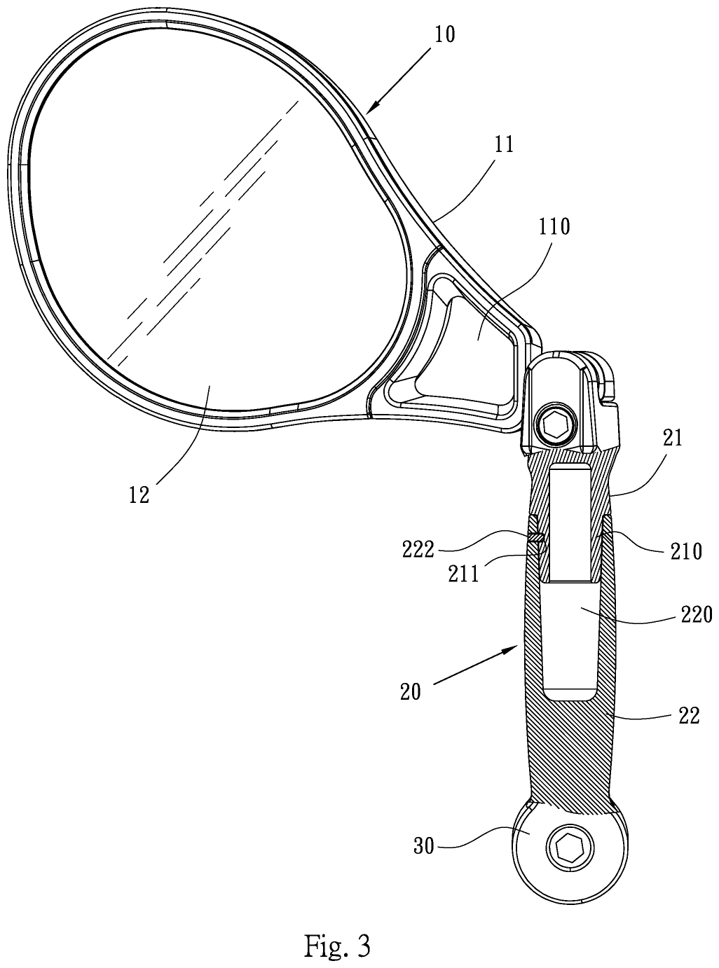

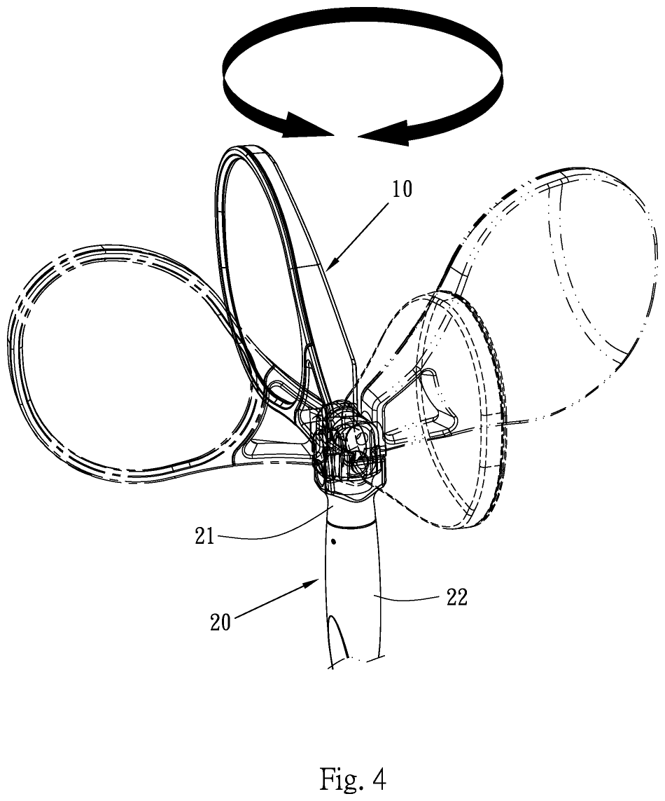

Please refer to FIGS. 1-4. The invention provides a bicycle rearview mirror 10 including a mirror frame 11 and a mirror mount 20. The mirror frame 11 is provided with a mirror 12. The end of the mirror frame 11, which is connected to the mirror mount 20, is formed with a through hole 110. The through hole 110 is helpful to lightweight.

The mirror mount 20 has an upper mount 21 and a lower mount 22. The upper mount 21 is pivotedly connected to an end of the mirror frame 11. The upper mount 21 is of a rod shape and has a shrunk section 210 which has a less diameter than the rest. Thus, an upper end of the shrunk section 210 forms a flange. The lower mount 22 is used for being fastened onto a handlebar of a bicycle and has a receiving hole 220 corresponding to the shrunk section 210 in shape so that the receiving hole 220 can be rotatably inserted by the shrunk section 210 and the flange is blocked by an edge of the receiving hole 220.

In this embodiment, a cylindrical surface of the shrunk section 210 is formed with an annular groove 211. The lower mount 22 is provided with a radial via hole 221 corresponding to the annular groove 211 in position. A fastener 222 is screwed into the radial via hole 221 to be embedded into the annular groove 211 so that the upper mount 21 can be rotated against the lower mount 22 when the fastener 222 is loosened and the upper mount 21 can be fixed to the lower mount 22 when the fastener 222 is tightened.

The radial via hole 221 may be a threaded hole and the fastener 222 may be a screw.

A bottom end of the lower mount 22 is provided with a fixing base 30 for connecting to a handlebar of a bicycle.

What is claimed is:

1. A rearview mirror for a bicycle, comprising:
a mirror frame; and
a mirror mount connected to an end of the mirror frame;
wherein the end of the mirror frame, which is connected to the mirror mount, is formed with a through hole.

2. A rearview mirror for a bicycle, comprising:
a mirror frame; and
a mirror mount, having an upper mount and a lower mount, the upper mount being pivotedly connected to the mirror frame and having a shrunk section, and the lower mount having a receiving hole for being inserted by the shrunk section.

3. The rearview mirror of claim 2, wherein the shrunk section is formed with an annular groove, the lower mount is provided with a radial via hole corresponding to the annular groove in position and a fastener is screwed into the radial via hole to be embedded into the annular groove.

4. The rearview mirror of claim 2, wherein the radial via hole is a threaded hole and the fastener is a screw.

5. The rearview mirror of claim 2, wherein a bottom end of the lower mount is provided with a fixing base for connecting to a handlebar.
